(19) United States
(12) Patent Application Publication
(10) Pub. No.: US 2022/0379783 A1
(43) Pub. Date: Dec. 1, 2022

(54) Temperature-Controlled Child Care Support and Transport Device

(71) Applicant: Joseph White, Hobbs, NM (US)

(72) Inventor: Joseph White, Hobbs, NM (US)

(21) Appl. No.: 17/745,098

(22) Filed: May 16, 2022

Related U.S. Application Data
(60) Provisional application No. 63/193,860, filed on May 27, 2021.

(51) Int. Cl. B60N 2/56

(52) U.S. Cl. CPC B60N 2/5657

(57) ABSTRACT

The present invention relates to a temperature-controlled child support and transfer device for cooling and warming a child positioned in the seat. More specifically, the seat has a Peltier unit for controlling temperature of air blowing onto the seat and has a fan unit for blowing air. The seat has a power source, a temperature control to control temperature and a fan control to control speed of the fan. In another embodiment, the seat has heating grids for providing heat to the seat and a fan unit coupled to a conduit for blowing cool air onto the seat. The seat can be used with vehicle, stroller, swing, crib, or bassinet.

### CROSS-REFERENCE TO RELATED APPLICATION

The present application claims priority to, and the benefit of, U.S. Provisional Application No. 63/193,860, which was filed on May 27, 2021, and is incorporated herein by reference in its entirety.

### FIELD OF THE INVENTION

The present invention relates generally to the child safety seats and systems. More specifically, the present invention relates to a novel child safety seat which can provide climate control for the child or infant and can be used inside a vehicle and can also be used in a stroller. The seat has integrated heating and cooling mechanisms to allow children to remain comfortable during hot and cold weather. The seat has controls for controlling temperature and regulating the flow of air blowing onto the seat and thus allows parents to choose hot or cold air to be circulated on the seat to make the children comfortable. Accordingly, the present disclosure makes specific reference thereto. Nonetheless, it is to be appreciated that aspects of the present invention are also equally applicable to other like applications, devices and methods of manufacture.

### BACKGROUND

By way of background, children, infants and newborns have different metabolisms in comparison to adults and therefore the children, infants and newborns may take time to adapt or regulate their body temperature to the temperature of the surrounding environment. While traveling outdoors, infants are often carried, placed in bassinets, pushed in strollers or ride in car seats in vehicles and as such, the baby may be exposed to hot or cold environmental conditions, that can be too hot or too cold for the baby and can eventually harm the baby's immune system. This leads the child becoming uncomfortable and potentially sickened by the environment.

Generally, the standard strollers, bassinets and other child carriers are technically advanced and normally provide just the basic arrangement of holding the child and the user may be unable to control the temperature of the stroller or other carrier to maintain a desirable environment for the infant or child.

Further, while traveling in vehicles, the infant or child is seated or placed in a car seat that is secured inside the vehicle. Usually, people use the air conditioning system of the vehicle to maintain a desired temperature for the infant or child seated in the vehicle. However, the air conditioning system works on cooling or heating the complete vehicle interior and fails to set a desired temperature for the infant or child only. The temperature requirements of the adults and the infant or child may be different. A desired temperature for both adults and infants may be unachievable inside the vehicle and would potentially leave both adults and infants uncomfortable.

In strollers, bassinets, or car seats, the child can become too hot or too cold, and may be uncomfortable while traveling outdoors. An uncomfortable child can quickly get upset, thereby requiring a parent or guardian to calm them down and disturbing others that are nearby. Constant temperature variations after getting in and out of a car, while traveling, etc. can lead to a child quickly getting sick.

Therefore, there exists a long-felt need in the art for a device that allows the users to take their infant or child outdoors without worrying about the child or infant getting sick. There is also a long-felt need in the art for a device that allows the users to easily and separately control the temperature of baby's environment, thereby ensuring the baby remains comfortable while travelling in a stroller, vehicle or placed in a bassinet. Additionally, there is a long-felt need in the art for a car seat that can be used in vehicles, strollers and bassinets as well. Moreover, there is a long-felt need in the art for a modified car seat that eliminates the use of vehicle's air conditioning system to cool the child and allows the users to maintain desired temperature for the child, while ensuring the comfort of adults as well. Further, there is a long-felt need in the art for an improved car seat that prevents significant temperature variations and therefore prevents the child from getting sick. Furthermore, there is a long-felt need in the art for an improved baby seat that prevents the child from being overheated, too cold, etc., and ultimately prevents the child from being uncomfortable. Finally, there is a long-felt need in the art for a modified car seat that can be conveniently used by parents, caregivers and other individuals for maintaining desired environment for infants and children while traveling outdoors.

The subject matter disclosed and claimed herein, in one embodiment thereof, comprises a temperature-controlled child care device. The safety care support can be used in a vehicle, installed in a stroller, bassinet, or crib. Further, the safety care device prevents children from becoming overheated, too cold, and maintains a suitable temperature environment to keep them comfortable. The seat or care device features a seating or child holding portion and a back or torso supporting portion for accommodating a child. The child care support may include a pivotable handle for carrying the seat or bassinet or pushing the stroller. A Lithium-ion rechargeable battery, and at least one fan unit coupled to the battery is configured to provide air through air filters to the back or torso portion and the seating supporting portion. The seat further has a Peltier unit coupled to the fan unit and is configured for controlling temperature of the air blowing by the fan unit. A control module is positioned on the handle and includes a display for providing temperature of air blown through the fan unit, a temperature controller knob for controlling temperature of the Peltier unit, a fan controller knob for controlling rotational speed of the fan unit and an activation button for activating and deactivating heating and cooling mechanism of the seat.

In this manner, the safety child seat, stroller, bassinet or crib of the present invention accomplishes all of the foregoing objectives and provides users with a modified car seat, stroller, bassinet or crib. The seat or other child care device has integrated heating and cooling mechanisms, allowing parents to choose warm or cool air delivered to the child sitting in the seat. The seat is secure and prevents children from being overheated or cold, in order to maintain a suitable and comfortable temperature environment and keeps the child happy and comfortable.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a temperature-controlled child care support device. The safety care device includes a supporting housing that has a seating portion, a back portion, a pivotable handle, a rechargeable battery, at least one fan unit coupled to the battery and is configured to provide air through air filters to the back portion and the seating portion. A Peltier unit is coupled to the fan unit and configured for controlling the temperature of the air blowing by the fan unit. A control module is positioned on the handle and includes a display for providing a readout of the temperature of air blowing through the fan unit. A temperature controller knob for controlling temperature of the Peltier unit, a fan controller knob for controlling the rotational speed of the fan unit and an activation button for activating and deactivating the heating and cooling mechanism of the seat.

In yet another embodiment, a temperature-controlled child safety seat configured to be attached to a stroller or other child care or transport device is disclosed. The child care transport device includes a base having a seating portion and a back supporting portion, a pivotable handle attached to the base using a pivoting hinge, an independent heating grid positioned in the seating portion and the back supporting portion. A fan unit is provided for producing cool air, and a conduit is connected to the fan unit for receiving the cool air from the fan unit and blowing the cooled or chilled air onto the base. The heating grids and the fan unit receives electric power from a power source, such as at least one of a rechargeable battery, a power outlet socket or plug inserted into a corresponding socket or a solar panel. The seat includes a Peltier unit for heating the heating grids or providing cool temperature to the fan unit.

In yet another embodiment, a child care support and transport device equipped with a child care support or transfer having an integrated heating and cooling mechanism is disclosed. The child care support and transfer device having a frame with the invention is disposed thereon. A removably attached sunshade, the sunshade having a flexible solar panel for absorbing solar energy and converting into electric energy. The child seat has a heating grid for heating the seat, a fan unit connected to a conduit for blowing cool air onto the seat, the heating grid and the fan unit are coupled to a rechargeable battery. The child care support and transport device further includes a pivotable handle having a control module disposed thereon for controlling heat provided by the heating grid and the air flow provided by the fan unit.

In yet another embodiment, a control module has a display displaying current temperature of the seat and an alarm for indicating if the temperature is too low or too high.

In yet another embodiment, the display provides a read out of the current ambient temperature.

In yet another embodiment, the child support and transfer device has a Peltier unit for controlling temperature of the heating grid and air blown by fan unit.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the temperature-controlled child care support and transfer device of the present invention in accordance with the disclosed architecture;

FIG. 2 illustrates a close-up view of the control module used in a potential embodiment of the child care support and transfer device of the present invention in accordance with the disclosed architecture;

FIG. 3 illustrates a perspective view of another potential embodiment of the temperature-controlled safety seat and care support and transfer device of the present invention in accordance with the disclosed architecture;

FIG. 4 illustrates a functional block diagram of an exemplary heating and cooling mechanism of one potential embodiment of the safety seat and care support and transfer device of the present invention using a Peltier unit in accordance with the disclosed architecture;

FIG. 5 illustrates a perspective view of one potential embodiment of the child safety care support and transfer device of the present invention installed in a vehicle with a child sitting in the seat in accordance with the disclosed architecture; and

FIG. 6 illustrates a perspective view of a stroller equipped with one potential embodiment of the child care support and transfer device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As indicated above, there is a long-felt need in the art for a child care support and transfer device which can be adapted for carrying, transporting and supporting a child or infant. The invention utilizes a heating and cooling system to enable the occupant of the device to remain comfortable without having to modify the surrounding area, which may lead to discomfort of others in the area. The present invention has a temperature control and may also include a temperature monitor for the child occupant so that the parent or guardian is able to monitor the temperature of the child and adjust the seat accordingly.

The present invention, in one exemplary embodiment, is a novel temperature-controlled child safety support device configured to be attached to a stroller, car seat frame, bassinet, or other child care support and which may be placed in a vehicle or crib. The safety support and care device includes a seating portion and a torso, or back, supporting portion, a pivotable handle, an independent heating grid positioned in the seating portion and the torso or back supporting portion. A fan unit is provided for producing cool air, and a conduit connected to the fan unit for receiving the cool air from the fan unit and blowing the cool or chilled air onto the base. The heating grids and the fan unit receive electric power from a power source, and the power source may be a rechargeable battery, an automobile power outlet socket inserted into a vehicle socket or a solar panel mounted on the support in a manner to collect solar energy. The seat includes a Peltier unit for heating the heating grids or providing cooling from the fan unit.

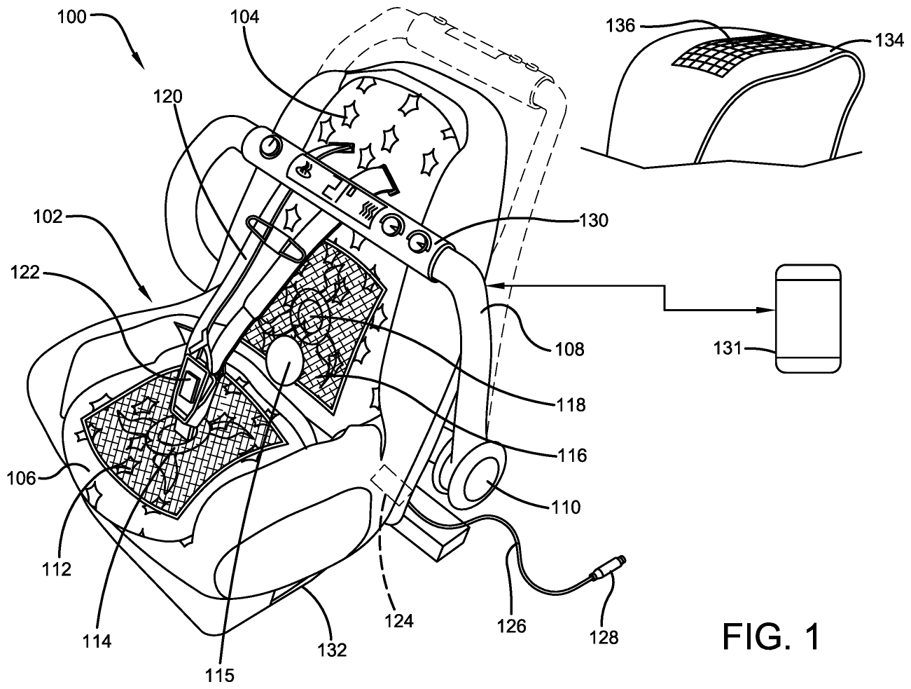

Referring initially to the drawings, FIG. 1 illustrates a perspective view of one potential embodiment of the temperature-controlled child safety support and transfer device 100 of the present invention in accordance with the disclosed specification. The temperature-controlled child support and transfer device 100 is designed to be used as a car seat, stroller seat, crib, or bassinet for a child and for maintaining an optimal and comfortable temperature thereby preventing the child from overheating, becoming too cold, and ultimately from being uncomfortable. More specifically, the child care support and transfer device 100 comprises a base or frame 102 that has a back or torso supporting portion 104 and a seating portion 106. A handle 108 is pivotally attached to the base or frame 102 at a pair of oppositely pivotable motion providing hinges 110 allowing the handle 108 to pivotably rotate sweeping over the back supporting portion 104 and the seating portion 106.

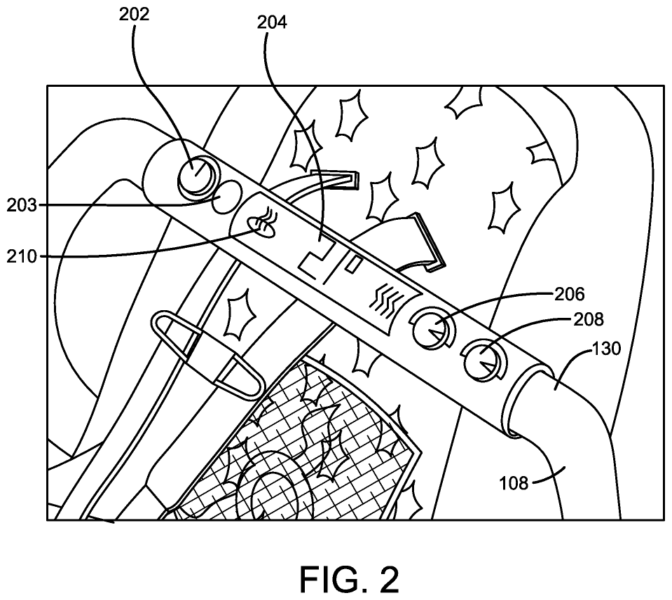

In the present embodiment, the seating portion 106 has a combined air vent and filter 112 for providing filtered air to a child sitting on the seat 100. The filter may be HEPA type filter for removing 99.97% of 0.3 microns from the air moving through the filter. The filter unit 112 may be connected to a filter indicator 203 (see FIG. 2) which shows the condition of the filter and when the filter may need to be changed. A first fan 114 is disposed inside the seating portion 106 for providing air and can be selectively and independently operated to control the fan speeds and direction of the air flow. The first fan 114 is disposed in a cavity (not shown) inside the seating or frame portion 106 and does not create any discomfort for a child sitting on the seating portion 106. The back or torso portion 104 has its own combined air vent and filter 116 for providing filtered air to the back or torso portion of a child. A second fan 118 is disposed in a cavity inside the back portion 104. The dimensions of the vents 112, 116 can be configured based on the size of the safety care support device 100 and similarly, the power and size of the fans 114, 118 are designed based on the requirements of the users and size of the occupant of the safety support and transport device 100.

The child care support and transport device 100 has a retractable belt 120 for providing securely retaining a child using the support 100 in position and prevents the child from rolling out of the device 100. The belt 120 can be secured around a child using the buckle 122 which is also used for adjusting the length of the belt 120 to accommodate children of various ages or sizes. For providing electrical power to the fans of the support 100, a power module 124 is disposed inside the frame of the support and transport device 100. The power module 124 can be in the form of a Lithium rechargeable battery that allows the fans 114, 118 to operate for at least fifteen hours. The battery 124 is positioned in a module and can be accessed when required to replace. The battery 124 may have a recharging port (not shown) for recharging the battery 124.

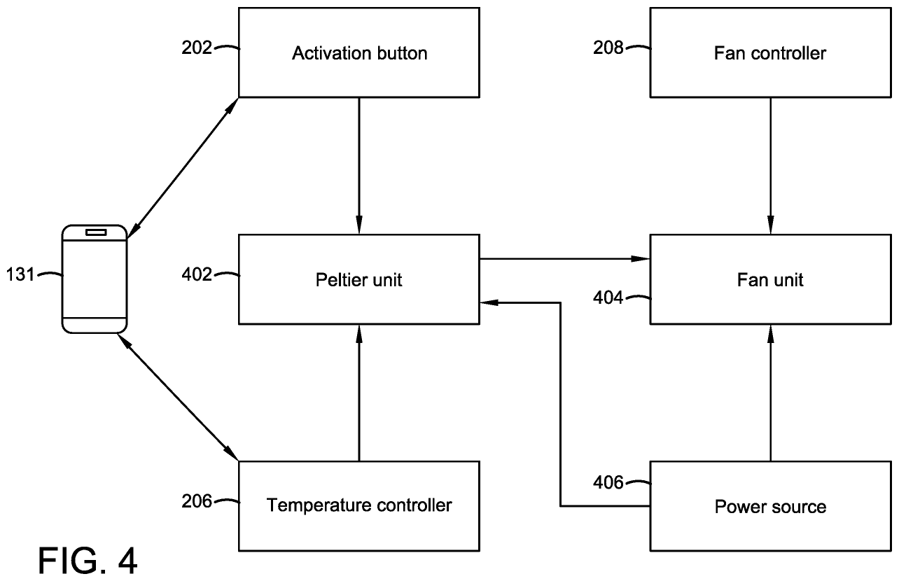

A connecting cord 126 connects the power module 124 to a 12V car power outlet connection socket adapter 128. The adapter 128 is configured to fit into a corresponding socket adapter of a vehicle allowing the power module 124 to receive power and operate fans 114, 118. It should be noted that the fans 114, 118 are connected to an internal thermoelectric Peltier unit (shown in FIG. 4) for providing both cool and warm air thereby providing comfort to child. The Peltier unit is configured to provide temperature in the range from ten degree Celsius, or fifty degrees Fahrenheit, to fifty degrees Celsius, or 122 degrees Fahrenheit.

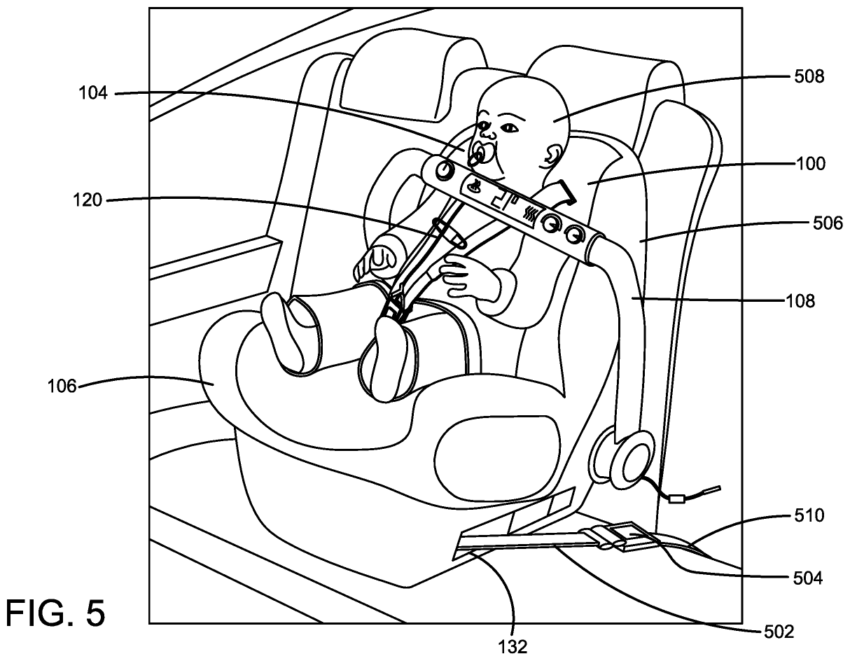

A control module 130 is disposed on the handle 108 for controlling temperature settings of the seat 100. The control module 130 is coupled internally with the Peltier unit, fans, and battery, thereby allowing a user, such as a parent of a child, to easily control temperature and fan settings as required by the user. The details of the control module 130 are described in FIG. 2. As stated earlier, the safety child seat 100 can be used in a vehicle, swing or crib and therefore has a buckle disposed inside buckle cover 132. The buckle cover 132 can be opened to access the buckle as shown in FIG. 5 for securing the seat 100 to safety belt of the vehicle. The device 100 may also include a child temperature module 115 which can monitor the temperature of the child and then provide feedback control to the heating or cooling units.

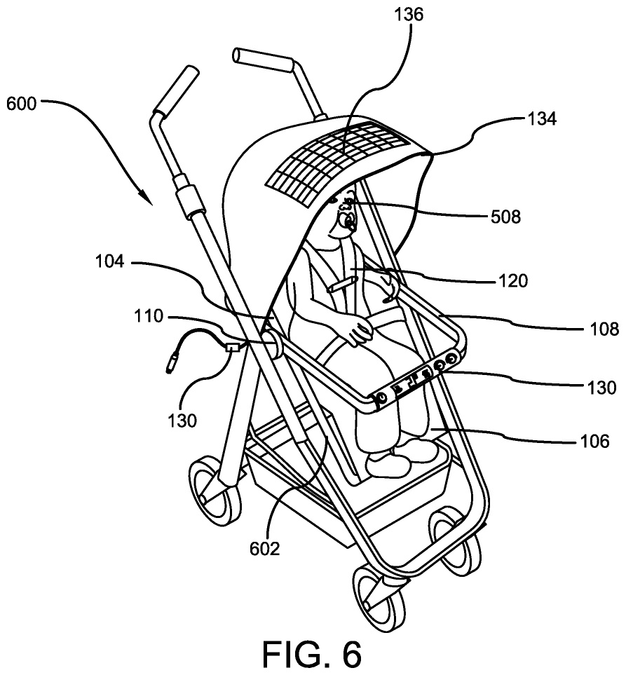

The seat 100 has an associated flexible sunshade 134 that can be removably attached to the seat or support 100 when the seat or support 100 is used with a stroller, crib, swing, or other item which may be exposed to sunlight as illustrated in FIG. 6. The sunshade 134 when attached to the seat 100 is configured to recharge the battery 124 using the electric power produced by the integrated solar panel 136. The solar panel 136 is flexible and has a plurality of photocells for converting solar energy into electric energy that can be used for recharging the power module/battery 124.

The vents 112, 116 are disposed and positioned allowing a steady flow of air to a child sitting in the safety seat 100. Further, the rotational speed of the fans 114, 118 can be adjusted as per desire of a child as described in FIG. 1.

The device 100 may also be connected to a smartphone 131 which has a previously downloaded application so that the parent or guardian can monitor the temperature of the child and device when not in the immediate vicinity. The smartphone can then change the temperature settings in order to maintain the child at a desired temperature.

FIG. 2 illustrates the close view of the control module 130 used in various embodiments of the child support and transfer device of the present invention in accordance with the disclosed specification. The control module 130 is mounted on the handle 108 and provides controls for controlling temperature and fan speed of the invention 100. More specifically, the control module 130 has an activation button 202 for activating and deactivating a heating and cooling mechanism of the seat 100. A digital display 204 is configured to display the temperature of the seat 100 and can be toggled between the seat temperature and the occupant temperature sensor 115 (see FIG. 1) and thus helps in indicating to a user the temperature. A temperature controller knob 206 is configured to increase temperature attained by Peltier unit when the knob 206 is rotated clockwise and decreases temperature of the Peltier unit when the knob 206 is rotated counterclockwise. A filter indicator 203 is also provided on the handle to alert the parent, guardian or owner of the device to change the filter.

A fan speed controller knob 208 is positioned on the control module 130 and is configured to increase rotational speed of the fans of the seat 100 when the knob 208 is rotated clockwise and decreases rotational speed of the fans when the knob 208 is rotated counterclockwise.

The display 204 is also configured to display an indicium 210 indicating speed and/or temperature of the seat or device 100 that helps in identification of correct temperature and/or speed for a child sitting in the safety seat or device 100. The display 204 can display temperature in various units of temperature including, but not limited to, Celsius and Fahrenheit.

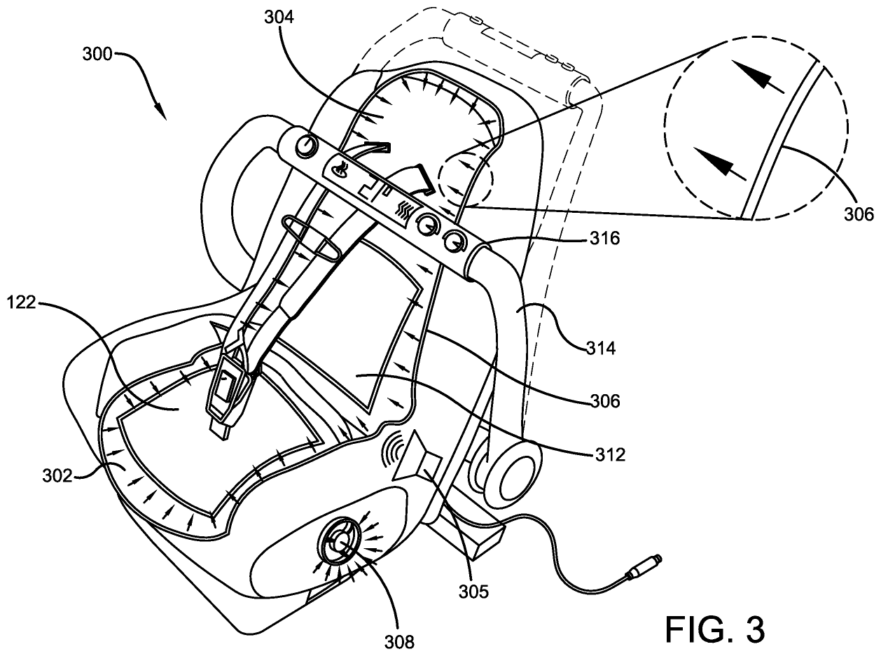

FIG. 3 illustrates a perspective view of another embodiment of the temperature-controlled safety seat or support and transport carrier of the present invention in accordance with the disclosed specification. The safety seat or support 300 of the present embodiment has a seating portion 302 and a back portion 304. A conduit 306 is positioned along the periphery of the seating portion 302 and the back portion 304 for venting out air (shown through arrows) produced by a fan unit 308. The fan unit 308 has an integrated cooling unit that produces cool air. The conduit 306 has vents along its length for blowing cool air and thus comforting a child sitting in the safety seat 300.

For providing heat to a child, the seating portion 302 has a first heating grid 310 and the back portion 304 has a second heating grid 312. The heating grids 310, 312 produce heat for comforting the child. The fan unit 308 and the heating grids 310, 312 receive electric power from a rechargeable battery (same as shown in FIG. 1). The handle 314 is pivotable and has a control module 316. The control module 316 has same functionality and characteristics as of the control module 130 of the other embodiments of the present invention. The support and transport device 300 may also be provided with a speaker 305 to play soothing sounds for the child while in the device.

It should be appreciated that the heating grids 310, 312 and the fan unit 308 are operable independently and simultaneously. Further, a Peltier unit is not required in the present embodiment and thus provides a simple operation. The fan unit 308 and the heating grids 310, 312 can be removed and replaced if a repair is required. The seat 300 has similar power mechanism using the power outlet socket and the rechargeable battery for providing electric power for functioning of the safety seat 300.

FIG. 4 illustrates a functional block diagram of an exemplary heating and cooling mechanism of the safety seat using Peltier unit in accordance with the disclosed specification. As illustrated, the activation button 202 is operable to activate the Peltier unit 402 and accordingly, the Peltier unit 402 receives power from the power source 406. The power source 406 can be one of rechargeable battery, power from automobile power outlet socket or solar panel.

The Peltier unit 402 is configured to be controlled using the temperature controller 206 allowing the Peltier unit 402 to increase or decrease temperature and thus accordingly, provide hot or cool air. The Peltier unit 402 is coupled to the fan unit 404 (collectively referred to the fan units shown in FIGS. 1 and 3) for providing cool or hot air. The fan controller 208 is coupled to the fan unit 404 and controls the rotational speed of the fans. Where a smartphone 131 is in use, the smartphone can be wirelessly connected to the activation control 202 and temperature controller 206 to remotely control operation of the device. Wireless networks can be provided in an automobile, home or other available network.

In other embodiment, the Peltier unit 402 can be used with separate heating grids and an air conditioner integrated fan unit may also be provided. All the components of the safety seat 100, 300 are connected through internal wired circuits that are insulated within the body of the seat and therefore provide safety to a child sitting in the safety seat.

FIG. 5 illustrates a perspective view of the child safety support and transfer device of the present invention installed in a vehicle with a child sitting in the seat in accordance with the disclosed specification. The present embodiment is described with the device 100 taken as the exemplary seat, however it should be appreciated that the child safety support and transfer device of the other embodiments can be installed and used in the same way inside a vehicle, stroller, crib, swing, or other item. The safety seat 100 is placed on a vehicle seat 506 and is secured by securing the buckle 504 to the safety belt 510 of the vehicle. The buckle 504 is accessed by removing the buckle cover 132 of the seat 100 and extending the buckle belt 502.

A child 508 is securely placed in the seat and is secured by the belt 120 positioned between the seating portion 106 and the back portion 104. The handle 108 can be appropriately positioned allowing easy movement of the child 508. The child 508 can be provided both hot air and cool air using the Peltier unit as described in FIGS. 1 and 4.

FIG. 6 illustrates a perspective view of a stroller equipped with the child safety seat of the present invention in accordance with the disclosed specification. As illustrated, the stroller 600 has a frame 602 the child safety support device 100 is placed thereon. The seat 100 is placed such that the seating portion 106 and the back portion 104 are positioned appropriately allowing the child 508 to sit in the seat easily and comfortably. For protecting the child from sun, the sunshade 134 is removably attached that has the solar panel 136. The sunshade 134 is attached to the pivotable hinge 110 and can be removed when is not required.

The handle 108 is appropriately positioned in front of the child 508 for additional support and the belt 120 is used for securing the child. The handle 108 is easily accessible to a user, such as a parent, for selecting the heating or cooling mechanisms and fan speed thereby providing comfort to the child 508.

It should be noted that the support and transfer device is designed to maintain an optimal and comfortable temperature for a child, preventing the child from overheating, getting too cold, and ultimately being uncomfortable. The temperature provided to the child can be cooled or heated properly and provides a proper sitting environment to the child during summer or winter and both indoor and outdoor.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “support and transfer”, “child safety seat”, “temperature-controlled child safety seat”, “safety seat”, and “seat”, are interchangeable and refer to the temperature-controlled child safety seat 100, 300 of the present invention.

Notwithstanding the foregoing, the temperature-controlled child safety seat 100, 300 of the present invention can be of any suitable size and configuration as is known in the art without affecting the overall concept of the invention, provided that it accomplishes the above-stated objectives. One of ordinary skill in the art will appreciate that the temperature-controlled child safety seat 100,300 as shown in the FIGS. are for illustrative purposes only, and that many other sizes and shapes of the temperature-controlled child safety seat 100, 300 are well within the scope of the present disclosure. Although the dimensions of the temperature-controlled child safety seat 100,300 are important design parameters for user convenience, the temperature-controlled child safety seat 100,300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A child support and transfer device comprising:
a frame configured to accommodate a child and having a seating portion and a back portion;
a temperature sensor provided in one of the seating or back portions of the frame;
a heating element and a cooling element provided in the frame for controlling a temperature of the child provided in the frame;
a power source connected to each of the heating and cooling elements; and
a switch for activating at least one of the heating and cooling elements.

2. The child support and transfer device as recited in claim 1, wherein the cooling element comprises a fan.

3. The child support and transfer device as recited in claim 1, wherein the heating element comprises a first heating grid and a second heating grid.

4. The child support and transfer device as recited in claim 3, wherein the first heating grid is provided in the seating portion.

5. The child support and transfer device as recited in claim 3, wherein the second heating grid is provided in the back portion.

6. The child support and transfer device as recited in claim 1, wherein the seating portion comprises a filter.

7. The child support and transfer device as recited in claim 6, wherein the filter is a HEPA filter.

8. The child support and transfer device as recited in claim 1, wherein the power source is one of a rechargeable battery, a solar panel or an automotive power outlet.

9. The child support and transfer device as recited in claim 1 further comprising a control panel.

10. The child support and transfer device as recited in claim 9, wherein the control panel comprises a display, an activation button, a temperature control and a fan speed control.

11. The child support and transfer device as recited in claim 9, wherein the control panel is mounted on a handle.

12. The child support and transfer device as recited in claim 1, wherein the child support and transfer device is sized and configured to be used with a car seat, a crib, a stroller, a bassinet or a swing.

13. A temperature-controlled child safety seat comprising:
a seat having a seating portion and a back portion;
a handle connected to the seat and comprising a control panel;
a temperature sensor provided in the seating portion;
a cooling fan for providing a cooling air to the seat; and
a heating element for providing a heat to the seat.

14. The temperature-controlled child safety seat as recited in claim 13, wherein the heating element comprises a first heating grid positioned in the seating portion and a second heating grid positioned in the back portion.

15. The temperature-controlled child safety seat as recited in claim 13, wherein the control panel comprises a display, an activation button, a temperature control and a fan speed control.

16. The temperature-controlled child safety seat as recited in claim 13 further comprising a Peltier unit connected to the heating element and the cooling fan.

17. The temperature-controlled child safety seat as recited in claim 13 further comprising a filter connected to the cooling fan.

18. The temperature-controlled child safety seat as recited in claim 13 further comprising a smartphone having a downloaded application, wherein the smartphone is in wireless communication with each of the temperature sensor and the control panel.

19. A child care support comprising:
a seat having a frame, and a seating portion and a torso portion, wherein the seating portion is comprised of a first heating grid and the torso portion is comprised of a second heating grid;
a cooling fan having an air filter;
a temperature sensor for detecting a temperature of the seat;
a temperature display for illustrating the temperature of the seat;
a control panel comprised of the temperature display, an activation button, a temperature control and a fan speed control; and
a temperature controller and a Peltier unit connected to each of the cooling fan and the first and second heating grids.

20. The child care support as recited in claim 19 further comprising a power source selected from a group consisting of a rechargeable battery, a solar panel and an automotive power outlet.
